(19) United States
(12) Patent Application Publication
(10) Pub. No.: US 2009/0128408 A1
(43) Pub. Date: May 21, 2009

(54) System and Method For Maintaining Antenna Pointing Accuracy During Periods of GPS Outage

(75) Inventors: Daniel J. Preston, Kew Gardens, NY (US); Anthony J. Calise, Collegeville, PA (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: ATAIR AEROSPACE, Brooklyn, NY (US)

(21) Appl. No.: 12/175,106

(22) Filed: Jul. 17, 2008

Related U.S. Application Data
(60) Provisional application No. 60/950,365, filed on Jul. 18, 2007.

(51) Int. Cl. G01S 5/14; H01Q 3/00

(52) U.S. Cl. 342/357.14; 342/359

(57) ABSTRACT

A method of computing an antenna pointing direction for an inertial navigation unit (INU) utilizing a global positioning system (GPS) signal during periods of GPS signal outage includes determining antenna pointing error of magnitude and phase information. The phase information is obtained by detecting the angle where a signal to noise ratio of the antenna passes through a minimum level, and wherein the magnitude information is obtained by calculating the difference between the maximum and minimum signal to noise ratio of the antenna measured over one conical cycle of rotation of the antenna about an axis that is not parallel to a vector pointing from an antenna center to a GPS signal transmitting satellite. During periods of GPS signal outage, the determined magnitude and phase information is used to cause a nominal antenna beam axis to move by an amount that depends on the determined magnitude information in a direction defined by the determined phase information.

### CROSS-REFERENCE TO RELATED APPLICATIONS

This application is related to and claims the benefit of U.S. provisional patent application 60/950,365 filed Jul. 18, 2007 entitled “Concept for maintaining antenna pointing accuracy during period of GPS outage” incorporated fully herein by reference.

### TECHNICAL FIELD

The present invention relates to navigational systems and more particularly, relates to a system and method for maintaining antenna pointing accuracy on a moving ground vehicle during periods of GPS outage.

### BACKGROUND INFORMATION

Utilizing a GPS navigational system for moving vehicles or people is well known. Under normal operation, a GPS aided inertial navigation unit (INU) is used to accurately determine vehicle attitude. The vehicle has a phased array antenna whose beam is steered to remain pointed at a communication satellite whose position in the sky is known.

Pointing must be maintained to within a few degrees of accuracy as the ground vehicle traverses an uneven terrain. This level of accuracy is achievable using a low cost GPS aided INU so long as it is properly calibrated at the start and the GPS signal is maintained.

During periods of GPS outage, attitude accuracy degrades with time due to variations that occur in gyro drifts and accelerometer biases. After a few moments of outage, it is possible to loose the ability to maintain track on the satellite. Even after the GPS is restored, a recalibration of the INU may be required to reacquire the satellite. This entails performing maneuvers that involve rotating the INU, which may not be operationally acceptable or possible.

Accordingly, what is needed is a system and method to maintain proper antenna pointing accuracy during periods when the GPS signal is unavailable or not strong enough to be tracked by an inertial navigation unit.

### BRIEF DESCRIPTION OF THE DRAWINGS

These and other features and advantages of the present invention will be better understood by reading the following detailed description, taken together with the drawings wherein:

FIG. 1 is graph illustrating a three-dimensional surface showing an antenna beam pointing error; and

FIG. 2 is a graft showing the dependence of signal to noise ratio on the antenna beam pointing error.

### DETAILED DESCRIPTION OF THE PREFERRED EMBODIMENTS

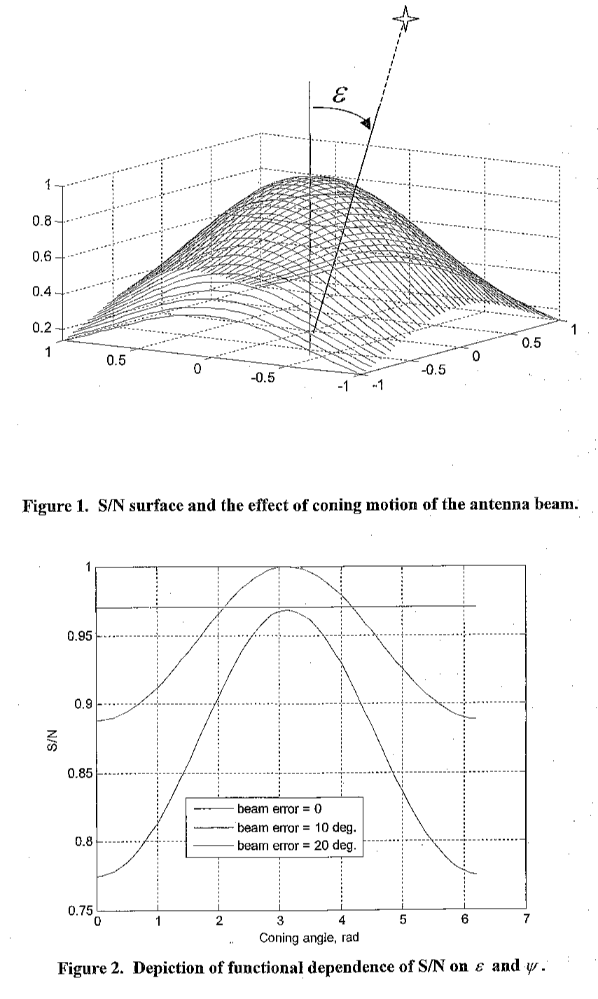

The approach described herein in accordance with the present invention relies on the fact that during normal operation, it is possible to obtain a measurement of the antenna's signal to noise (S/N) ratio. Consider the 3 dimension surface illustrated in FIG. 1. This depicts a typical dependence of S/N ratio as a function of pointing error. In this depiction, pointing error is represented by the tip of a unit vector pointing from the antenna center to the satellite and projected onto a plane perpendicular antenna beam. Thus if the antenna beam is pointed directly at the satellite, the S/N ratio would be at its maximum value. The vertical blue line in this figure represents the direction of the antenna beam. In this depiction it is assumed that the S/N surface has a symmetric bell shape about the beam axis.

If the antenna beam axis is driven in a coning motion about the blue axis depicted in FIG. 1, the S/N ratio will fluctuate in a manner that depends on the angle between the blue axis and the unit vector pointing from the antenna center and the satellite. We will refer to this angle as the beam error angle (ε), and the coning angular position of beam about the blue axis will be called ψ.

If, for example, ε=0, then the S/N ratio will be constant as the beam is rotated if the dependence of S/N is symmetrical about the beam axis. If on the other hand ε>0. then the S/N ratio will fluctuate in a manner that depends on ψ and the shape of the surface, as represented by the black line shown in FIG. 1. Note that the black line depicted in FIG. 1 has somewhat of a warped shape (the points on this line do not lie in a plane that is perpendicular to the blue line). It is this warped shape that cause the fluctuation that is seen in the S/N ratio if it is plotted as a function of ψ.

For illustrative purposes, the surface in FIG. 1 was obtained using the following functional form:

z=exp{x*s+y*y} (Equation 1)

For this surface FIG. 2 shows the resulting dependence of S/N on ε and ψ as the beam moves in a cone whose surface makes an angle of 10° with the nominal pointing axis (the blue axis in FIG. 1),

Note that the S/N ratio passes through a maximum and a minimum for each complete rotation ψ. This shows that we can obtain both amplitude and phase information concerning the antenna pointing error. The phase is obtained by detecting the angle ψ where the S/N ratio passes through a minimum, and the magnitude is obtained from the difference between the maximum and the minimum S/N ratio measured over one cycle of rotation. The preferred embodiment of the magnitude measure would be

M=(S/Nₘₐₓ−S/Nₘᵢₙ)/(S/Nₘₐₓ) (Equation 2)

Note that in Eq. (2) the difference between the maximum and minimum S/N ratio is normalized by the maximum S/N ratio. This helps to remove the dependence that this measure has on the peak value of the S/N ratio, which for example can vary with the angle that the satellite makes with the local horizontal plane and other geometry related factors that effect antenna performance.

The magnitude and phase information derived from the process described above can be used to move the nominal axis of the beam (blue line in FIG. 1) by an amount that depends on M and in a direction defined by the phase. The functional dependence of the amount M moves the bean can be calibrated for a specific antenna by measuring and tabulating the S/N ratio surface.

Accordingly, the present invention provides a novel and non-obvious system and method for maintaining antenna pointing accuracy during periods of GPS outage.

Modifications and substitutions by one of ordinary skill in the art are considered to be within the scope of the present invention, which is not to be limited except by the allowed claims and their legally equivalents.

The invention claimed is:

1. A method of computing an antenna pointing direction for an inertial navigation unit (INU) utilizing a global positioning system (GPS) signal during periods of GPS signal outage, said method comprising the acts of:
determining antenna pointing error of magnitude and phase information, said phase information obtained by detecting the angle where a signal to noise ratio of said antenna passes through a minimum level, and wherein said magnitude information is obtained by calculating the difference between the maximum and minimum signal to noise ratio of said antenna measured over one cycle of rotation of said antenna about an axis that is not parallel to a vector pointing from an antenna center to a GPS signal transmitting satellite; and
using said determined magnitude and phase information to cause a nominal antenna beam axis to move by an amount that depends on said determined magnitude information in a direction defined by said determined phase information.
